(19) United States
(12) Patent Application Publication
(10) Pub. No.: US 2005/0116092 A1
(43) Pub. Date: Jun. 2, 2005

(54) Blended leading and trailing edge wing planform

(76) Inventors: Robert D. Gregg III, Fullerton, CA (US); Dennis L. McDowell, Huntington Beach, CA (US)

Correspondence Address: HARNESS, DICKEY & PIERCE, P.L.C., P.O. BOX 828, BLOOMFIELD HILLS, MI, 48303, US

(21) Appl. No.: 10/717,366

(22) Filed: Nov. 19, 2003

(51) Int. Cl. B64C 3/00

(52) U.S. Cl. 244/35 R

(57) ABSTRACT

A wing having a transition region forming a blended, aerodynamic transition between inner and outer regions of the wing. The blended transition region does not include any planform breaks at the leading and trailing edges, where conventional wings would have such planform breaks. This allows the wing to be manufactured without significant forming and/or shot-peening operations to conform the skin of the wing to the planform breaks. Thus, the wing of the present invention can be manufactured with less cost and in less time, and provide even better aerodynamics than conventional aircraft wings. The wing of the present invention is further suitable for use on aircraft or aerospace vehicles, or any airborne vehicle requiring one or more aerodynamic airfoils or wing-like structures.

### FIELD OF THE INVENTION

The present invention relates to the construction of wings for aircraft and aerospace vehicles, and more particularly to a wing for such vehicles that includes blended leading and trailing edges with no planform breaks at these edges.

### BACKGROUND OF THE INVENTION

With present day aircraft and aerospace vehicles, wings employed on such vehicles typically include a “planform break” along a trailing edge portion of the wing, and often also along a leading edge portion the wing, at a transitional region where the fore-to-aft length of the wing increases to meet the fuselage of the aircraft or aerospace vehicle. An example of this is shown in FIG. 1. A wing 10 includes a transition region within dashed lines 12 which separates an outer portion 14 of the wing from an inner portion 16 which is coupled to a fuselage 18 of the aircraft or aerospace vehicle. Within the transition region 12, a first planform break 20 is included along a leading edge 22 of the wing 10, as well as a second planform break 24 along a trailing edge 26 of the wing. The planform breaks 20 and 24 form spanwise surface discontinuities that cause significant difficulties and additional expense in the manufacturing of the wing 10. Particularly, these spanwise discontinuities add to the manufacturing costs and complexity by requiring significant forming and/or shot-peening of the skin to make the skin conform to these planform breaks and surface discontinuities. As will be appreciated, these extensive forming and/or shot-peening operations necessary to conform the skin to the planform breaks and surface discontinuities adds considerable costs to the manufacturing process. Furthermore, excessive skin thickness in the transition region will result in even more complex and costly forming and/or shot-peening of the skin to achieve the required, abrupt contours at these planform break locations 20 and 24.

Accordingly, it would be highly desirable to provide a wing for an aircraft or aerospace vehicle that does not include the abrupt planform breaks 20 and 24 of wing 10 described above. Such a wing would enable skin panels in transition region 12 to be shaped by simple forming techniques or possibly draped over the spars and stringers, rather than extensive forming and/or shot-peening operations necessary to conform the skin to the abrupt planform and surface breaks.

### SUMMARY OF THE INVENTION

The present invention is directed to a wing and a method of forming the wing which eliminates the typical planform breaks described above. The wing includes a transition region having a smoothly tapering leading edge and smoothly tapering trailing edge. Because of this blended transition region, the skin panels in this region can be shaped by simple forming methods or even draped over the spars and stringers during manufacturing without the need for complex forming and/or shot-peening operations that would typically be required to conform the skin to the abrupt planform breaks and surface discontinuities.

The use of the blended transition region described immediately above allows a wing for an aircraft or aerospace vehicle to be made with lower cost and less time than a conventional wing having the planform breaks described in connection with FIG. 1. Furthermore, the wing of the present invention, due to a more smoothly varying spanload, is even more aerodynamically efficient than the conventional wing shown in FIG. 1.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified plan view of one prior art wing of an aircraft illustrating the transition region where planform breaks are introduced at the leading and/or trailing edges of the wing in conventional wing construction; and

FIG. 2 is a planview of an aircraft wing in accordance with a preferred embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

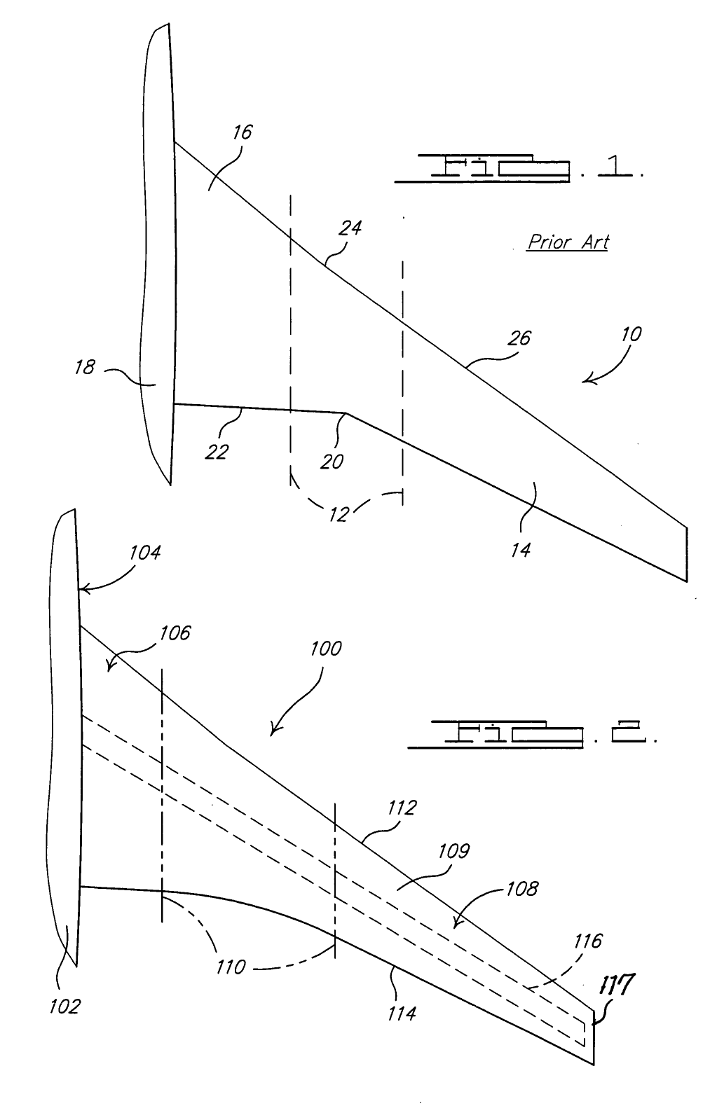

Referring to FIG. 2, there is shown a wing or airfoil 100 in accordance with the preferred embodiment of the present invention. Simply for convenience, the term “wing” will be used throughout the following discussion. The wing 100 is coupled to fuselage 102 of an aircraft 104. The wing 100 includes an inner region 106, an outer region 108 and a transition region 110. A leading edge 112 extends spanwise along the full length of the wing 100, while a trailing edge 114 similarly extends spanwise along the full length of the wing. The transition region 110, as will be noted immediately, forms a smooth gradually curving region which integrates the inner region 106 and outer region 108 of the wing 100. One or more skin panels 109 are used to form a smooth, outermost surface for the wing 100. Accordingly, there are no abrupt, spanwise planform breaks in the transition region 110. The complete absence of these planform breaks allows the wing 100 to be constructed by simple forming or by draping of the skin 109 over the spars and stringers in the transition region 110, rather than requiring complex or extensive forming and/or shot-peening operations to conform the skin 109 in the areas where planform breaks would normally occur. Thus, each of the leading and trailing edges 112 and 114, respectively, along with transition region 110 form smooth surfaces devoid of any abrupt planform breaks or surface discontinuities. The elimination of the planform breaks and the resulting smooth blending of transition region 110 thus enables the wing 100 to be made with fewer manufacturing steps using simpler methods at a lower cost than the wing 10 of FIG. 1. Furthermore, the aerodynamics of the wing 100 are improved by the absence of the planform breaks at the leading and trailing edges 112 and 114, respectively, because of the more smoothly varying spanwise load distribution.

The transition region 110 of the wing 100 preferably use the same type of non-linear smoothly varying curve to define both the planform blended shape as well as the spanwise surface shape. The spanwise surface of wing 100, including transition region 110, is defined by a sequence of airfoils rigged along the span combined with a series of smoothly varying curves, running spanwise, that each follow constant chordwise element lines. The non-linear curves that define the planform shape and spanwise surface for transition region 110 are preferably a form of cubic, such as a parametric cubic, which conform to the required geometric coordinates of transition region 110 and constraints imposed by regions 106 and 108 on either side of the transition region. However, any smoothly varying curve such, as a parabolic or 4^{th} order curve, may be used as long as it properly conforms to the geometric requirements of transition region 110 and constraints of regions 106 and 108.

The wing 100 of the present invention thus forms a structure that is suitable for use with an aircraft, aerospace vehicle, or any other airborne vehicle requiring the use of one or more aerodynamically shaped wing-like structures, and which can be produced at a lower manufacturing cost and in less time than a conventional wing having planform breaks. The wing 100 of the present invention further provides improved aerodynamic characteristics over a conventional wing having planform breaks at the leading and/or trailing edges.

The description of the invention is merely exemplary in nature and, thus, variations that do not depart from the gist of the invention are intended to be within the scope of the invention. Such variations are not to be regarded as a departure from the spirit and scope of the invention.

1. A wing for an airborne mobile platform, comprising:
a first region having linear converging leading edge and trailing edge surfaces;
a second region having linear converging leading edge and trailing edge surfaces; and
a transition region in between said first region and said second region, said transition region forming a smooth, gradually curving surface devoid of a planform break for at least one of a leading edge and a trailing edge of said wing.

2. The wing of claim 1, wherein said transition region forms a smooth, gradually curving surface devoid of planform breaks at both of said leading edge and said trailing edge of said wing.

3. The wing of claim 1, wherein said first linear region is adapted to be coupled to a fuselage of said airborne mobile platform.

4. A wing for an aircraft, comprising:
a first region having linear converging leading edge and trailing edge surfaces, adapted to be coupled to a fuselage of said aircraft;
a second region having linear converging leading edge and trailing edge surfaces forming an outer portion of said wing;
a transition region disposed in between said first and second regions, said transition region forming a gradually curving surface at least at one of a leading edge and a trailing edge of said wing that is devoid of a planform break.

5. The wing of claim 4, wherein said transition region forms gradually curving surfaces at both of said leading edge and said trailing edge of said wing, such that both of said leading and trailing edges are devoid of planform breaks.

6. The wing of claim 4, wherein said transition region is adapted to be coupled to a fuselage of said aircraft.

7. An airfoil for an aerospace vehicle, comprising:
a first region having converging leading edge and trailing edge surfaces;
a second region having converging leading edge and trailing edge surfaces; and
a transition region disposed in between said first and second regions, said transition region forming a smooth, gradually curving surface at least at one of a leading edge and a trailing edge of said airfoil, that is devoid of a planform break.

8. The airfoil of claim 7, wherein said transition region includes smooth, gradually curving surfaces at both of said leading edge and said trailing edge of said airfoil.

9. The airfoil of claim 7, wherein said first region is coupled to a fuselage of said aerospace vehicle.

10. A method of forming an airfoil for an aerospace vehicle, comprising:
forming a first region of said airfoil having linear converging leading edge and trailing edge surfaces, that is adapted to be coupled to a fuselage of said vehicle;
forming a second region of said airfoil having linear converging leading edge and trailing edge surfaces;
forming a transition region in between said first and second regions such that said first region, said second region and said transition region cooperatively form said airfoil and such that said transition region forms a gradually curving surface at least at one of a said leading edge and a trailing edge of said transition region of said airfoil that is devoid of a planform break.

11. The method of claim 10, further comprising forming said transition region such that both of said leading and trailing edges of said airfoil, at said transition region, form gradually curving surfaces that are devoid of planform breaks.

12. A method of forming a wing for an aircraft, comprising:
forming a first region of said wing with linear, converging leading edge and trailing edge surfaces;
forming a second region of said wing with linear converging leading edge and trailing edge surfaces;
forming a transition region in between said first and second regions such that said first region, said second region and said transition region cooperatively form said wing, and such that said transition region forms a gradually curving surface at least at one of a leading edge and a trailing edge of said airfoil that is devoid of a planform break.

13. The method of claim 12, wherein said transition region forms a gradually curving surface at both of said leading and trailing edges of said transition region.

14. The method of claim 13, further comprising securing said skin panel over said airfoil support structure such that said skin panel extends over both said leading and trailing edges of said airfoil support structure and forms a smoothly varying, continuous, aerodynamic surface from said leading edge to said trailing edge.
